(19) United States
(12) Patent Application Publication
(10) Pub. No.: US 2008/0138150 A1
(43) Pub. Date: Jun. 12, 2008

(54) Ball-And Socket Joint

(76) Inventors: Frank Budde, Damme (DE); Thomas Richter, Damme (DE)

Correspondence Address: MCGLEW & TUTTLE, PC, P.O. BOX 9227, SCARBOROUGH STATION, SCARBOROUGH, NY, 10510-9227, US

(21) Appl. No.: 11/574,534

(22) PCT Filed: Aug. 24, 2005
(86) PCT No.: PCT/DE05/01491

§ 371 Date: Jul. 12, 2007

(30) Foreign Application Priority Data
Sep. 2, 2004 (DE) 10 2004 041 965.0

(51) Int. Cl. F16C 11/06

(52) U.S. Cl. 403/135

(57) ABSTRACT

A ball and socket joint for a motor vehicle, especially for a rocker pendulum of a motor vehicle, has a housing (1), which is open on at least one side, and into the interior space of which a bearing shell is inserted, which in turn accommodates a joint ball of a ball pivot in a slidingly movable manner. According to a first variant, the interior space has elevations along its inner jacket surface, which said elevations mesh with the bearing shell in a positive-locking manner. The elevations are designed as triangular webs (13). According to a second variant, the interior space has depressions along its inner jacket surface, which said depressions mesh with the bearing shell in a positive-locking manner, said depressions being designed as undercuts.

### CROSS REFERENCE TO RELATED APPLICATIONS

This application is a United States National Phase application of International Application PCT/DE2005/001491 filed Aug. 24, 2005 and claims the benefit of priority under 35 U.S.C. § 119 of German Patent Application DE 10 2004 042 965.0 filed September 2004, the entire contents of which are incorporated herein by reference.

### FIELD OF THE INVENTION

The present invention pertains to a ball and socket joint for a motor vehicle, especially for a rocker pendulum of a motor vehicle, with a housing, which is open on at least one side and into the interior space of which a bearing shell is inserted, which in turn accommodates a joint ball of a ball pivot in a slidingly movable manner.

### BACKGROUND OF THE INVENTION

A ball and socket joint with an annular housing and with a bearing shell, which is inserted therein and in which a ball pivot is mounted, is known from DE 43 06 006 A1. On its outer circumference, the bearing shell has a contour, which meshes with a complementary contour of the internal diameter of the housing for securing against rotary motions about the central axis of the ball pivot.

However, it happens in ball and socket joints known from the state of the art that the contour of the bearing shell separates from the complementary contour of the housing with increasing use, so that the securing against rotation may fail.

### SUMMARY OF THE INVENTION

The object of the present invention is therefore to provide a ball and socket joint of the type mentioned in the introduction, in which the securing against rotation is improved compared to the state of the art.

According to the first variant, a ball and socket joint for a motor vehicle, especially for a rocker pendulum of a motor vehicle, is provided with a housing, which is open on at least one side and into the interior space of which a bearing shell is inserted, which in turn accommodates a joint ball of a ball pivot in a slidingly movable manner, wherein the interior space has elevations along its inner jacket surface, which said elevations mesh with the bearing shell in a positive-locking manner. The elevations are designed as triangular webs.

Rotation is reliably prevented from occurring in the bearing shell according to the present invention, because it was shown that the shell does not become loose from the housing. The ball and socket joint according to the present invention can be manufactured by mass production at low cost, and the securing against rotation is improved compared to the state of the art.

The triangular webs may extend obliquely in relation to the central longitudinal axis, e.g., along a zigzag line. However, the triangular webs preferably extend in parallel to the central longitudinal axis of the housing, as a result of which especially simple mounting of the ball and socket joint is possible by pressing the bearing shell into the interior space while the outer jacket surface of the bearing shell undergoes plastic deformation.

The triangular webs may extend only over part of the length of the inner jacket surface of the housing, but the triangular webs preferably extend over the entire length of the inner jacket surface of the housing. As a result, especially high torques can be transmitted between the bearing shell and the housing.

The cross section of the triangular webs may have the shape of a scalene triangle. However, the triangular webs are preferably formed with two equal side surfaces, the angle bisectrix of the angle formed between the two equal side surfaces passes through the central longitudinal axis of the bearing. It is guaranteed according to this embodiment that the securing against rotation will act equally concerning both directions of rotation that are possible about the central longitudinal axis.

The radial height of the triangular webs can be varied according to the use and the load of the ball and socket joint. However, especially good securing against rotation was achieved when the radial height of the triangular webs is equal to the product of the shell thickness of the bearing shell and the stretch elongation of the material used for the bearing shell.

The two equal side surfaces of each triangular web preferably form a right angle. A larger opening angle could facilitate the sliding off of the bearing shell from the triangular webs, whereas a smaller angle could increase the notch sensitivity of the material of the bearing shell. Nevertheless, other opening angles are possible insofar as this is allowed by the use and the load of the ball and socket joint.

Any desired number n_{Steg} of triangular webs is possible, in principle, to form the means securing against rotation according to the present invention. However, it was found that this number n_{Steg} becomes optimal when it is greater than or equal to the even-numbered rounded-up quotient of the maximum torque to be transmitted Mₘₐₓ to the product of the area of the webs A_{Steg}, the shear strength σsₘₐₓ of the material of the bearing shell and the effective bearing shell radius r. Thus,

n_{Steg}≈Mₘₐₓ/(A_{Steg}*σsₘₐₓ*r).

The effective bearing shell radius r extends here, starting from the center of the ball, to an area between the inner edge and the outer edge of the bearing shell, the radius up to the inner edge of the bearing shell being designated by r_{Innen} and the radius up to the outer edge of the bearing shell by r_{Auβen}. Thus, the following relationship applies to the effective bearing shell radius r:

r_{Innen}≦r≦r_{Auβen},

the optimal value of r depending on the depth to which the triangular webs mesh with the bearing shell. A good value for r was obtained when r=r_{Auβen} was selected.

The bearing shell is preferably made of plastic, especially polyoxymethylene, the bearing shell being able to be introduced into the housing while its outer circumferential surface undergoes plastic deformation, if the bearing shell was not yet provided before the mounting with the depressions that mesh with the triangular webs in the assembled state of the ball and socket joint.

In principle, there may be a gap between the outer circumferential surface of the bearing shell and the inner jacket surface of the housing. However, the bearing shell preferably has a small oversize concerning the inner jacket surface of the housing, so that it is seated in the housing under a slight radial pressure. The slackness can be avoided as a result and dirt can be prevented from entering.

According to the second variant of the present invention, a ball and socket joint is provided for a motor vehicle, especially for a rocker pendulum of a motor vehicle, with a housing, which is open on at least one side and into the interior space of which a bearing shell is inserted, which in turn accommodates a joint ball of a ball pivot in a slidingly movable manner, the interior space having depressions along its inner jacket surface, which said depressions mesh with the bearing shell in a positive-locking manner. The depressions are designed as undercuts.

The bearing shell is prevented from becoming loose from the housing by this variant as well, as a result of which an especially good and durable means securing against rotation is formed. As in the first variant, the ball and socket joint according to the second variant can be manufactured by a mass production process at low cost.

The undercuts may extend obliquely in relation to the central longitudinal axis, e.g., along a zigzag line. However, the undercuts preferably extend in parallel to the central longitudinal axis of the housing, as a result of which especially simple mounting of the ball and socket joint is possible.

The depressions may extend, in principle over the entire length of the housing. However, a sufficient securing against rotation is already achieved when the depressions, which are open towards one front side of the housing, extend only over part of the length of the inner jacket surface. It proved to be advantageous in this connection when the depressions have a rectangular or triangular profile with respect to a longitudinal section of the housing.

The bearing shell is manufactured preferably from a plastic, especially polyoxymethylene, the bearing shell being able to be molded into the depression by ultrasonic deformation.

The present invention will be described below on the basis of preferred embodiments with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a longitudinal sectional view through a first embodiment of the ball and socket joint according to the present invention in the partially mounted state;

FIG. 2 is a longitudinal sectional view of the embodiment according to FIG. 1 in the completely mounted state;

FIG. 3 is a cross sectional view of the housing according to the first embodiment according to the first variant of the present invention;

FIG. 4 is the cross sectional view of a triangular web according to FIG. 3;

FIG. 5 is the longitudinal sectional view of the housing according to FIG. 3 along the plane of section A-A′;

FIG. 6 is the cross sectional view of the housing according to FIG. 3 with the calibrating tool inserted;

FIG. 7 is the cross sectional view of a housing according to a second embodiment according to the second variant of the present invention;

FIG. 8 is the enlarged view of an undercut according to FIG. 7 with a projection of the bearing shell meshing with same the undercut; and

FIG. 9 is a longitudinal sectional view of the housing according to FIG. 7 along the plane of section B-B′, wherein two subvariants are shown for the profile of the undercut.

### DESCRIPTION OF THE PREFERRED EMBODIMENTS

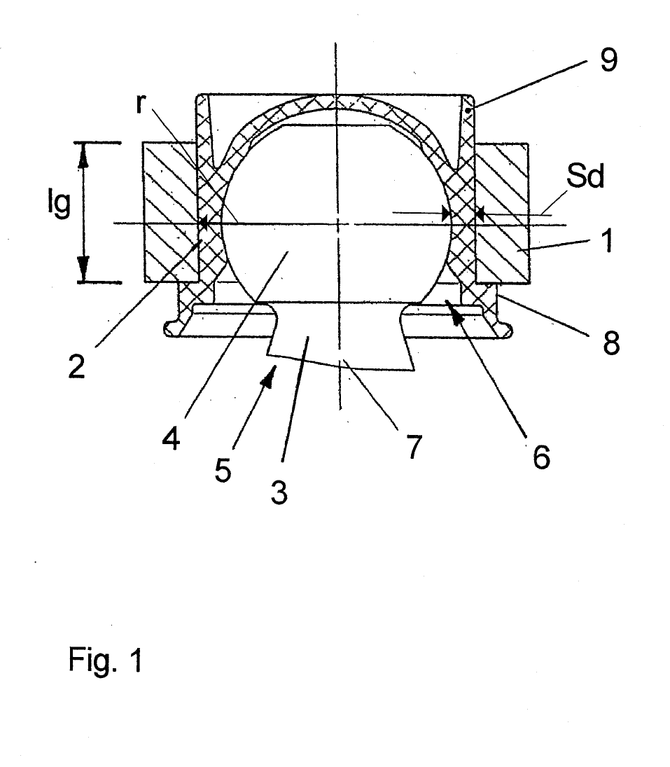

Referring to the drawings in particular, according to FIG. 1, a bearing shell, in which a ball pivot 5 having a pivot 3 and a joint ball 4 is mounted in a slidingly movable manner, is inserted into an annular housing 1. The ball pivot 5 extends through an opening 6 provided in the bearing shell 2 and out of the ball and socket joint and can be rotated about the central longitudinal axis 7 of the ball and socket joint as well as pivoted at right angles to this about a point of pivoting in the joint ball 4. In the area of the opening 6, the bearing shell 2 is in contact with a front side of the housing 1 via an outer shoulder 8, whereas a collar 9 projects from the housing 1 at the end of the bearing shell 2 facing away from the outer shoulder 8.

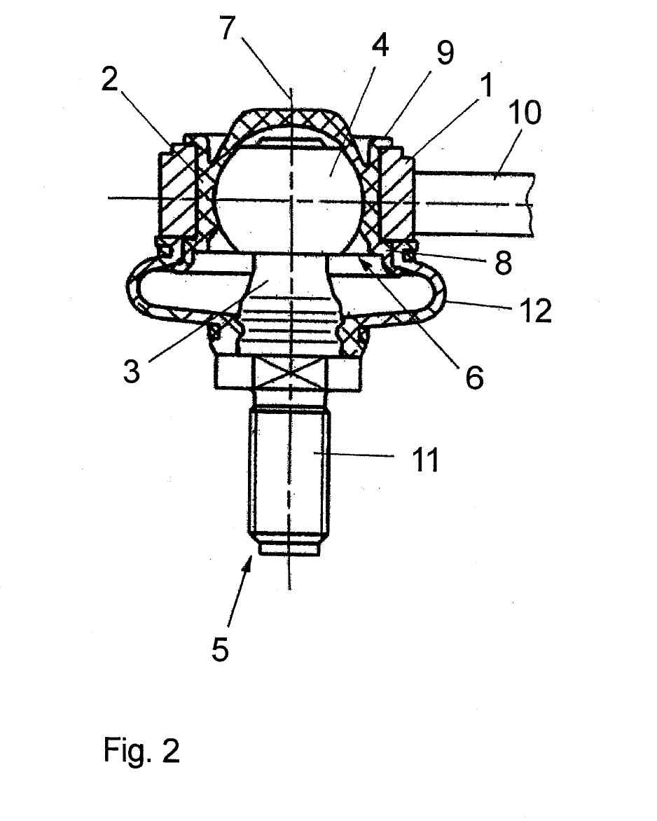

FIG. 2 shows that the collar 9 for the axial fixation of the bearing shell 2 in the housing 1 has been folded over radially to the outside by deforming the material, the folding over being preferably carried out by using the ultrasonic deformation method. The ball and socket joint according to this embodiment is designed for the transmission of a maximum torque Mmax of 15 Nm between the housing 1 and the bearing shell 2, the bearing shell manufactured from POM having a shell thickness Sd of 1.5 mm and a stretch elongation s of approx. 10%. However, another embodiment may be also be designed for the transmission of a maximum torque Mmax of 20 Nm between the housing 1 and the bearing shell 2.

The housing 1 is made in one piece with a first motor vehicle part 10, a threaded area being provided at the pivot 3 for fastening a second motor vehicle component. To prevent dirt and moisture from entering the ball and socket joint, a seal 12 consisting of an elastic material, especially rubber, is provided between the ball pivot 5 and the bearing shell 2, but the seal 12 may also be arranged between the ball pivot 5 and the housing 1.

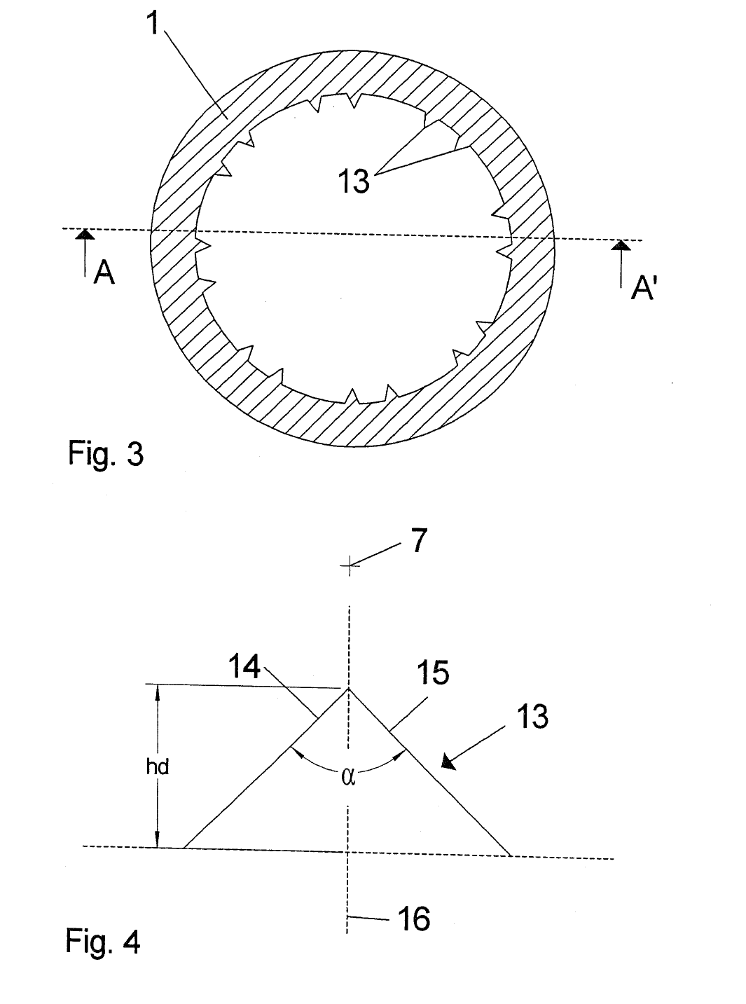

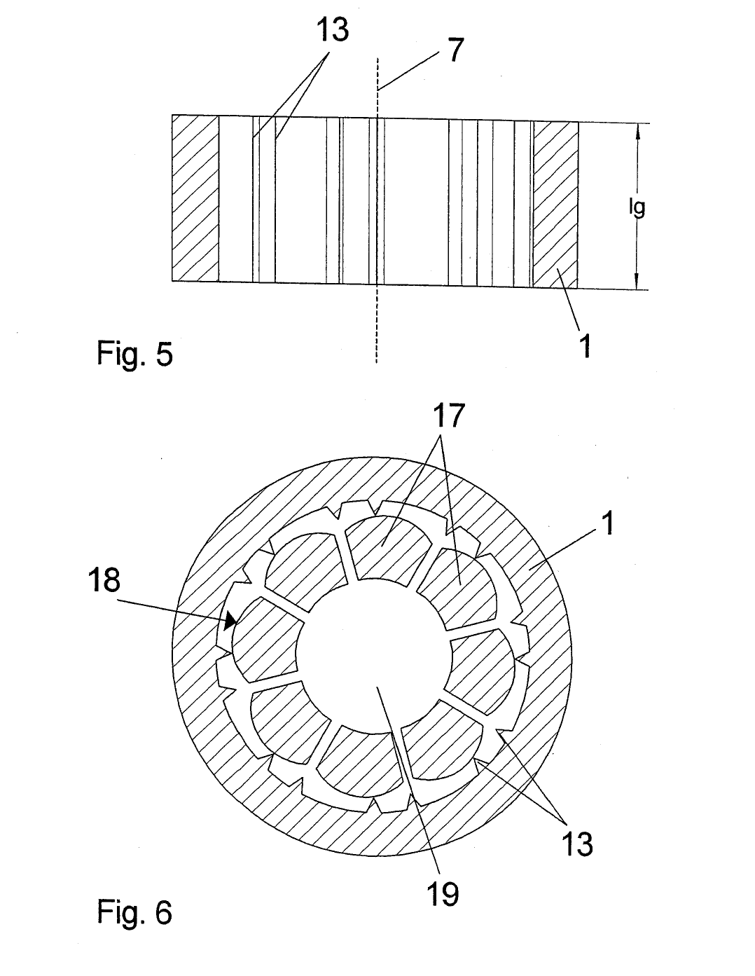

The triangular webs 13, which are provided according to the first variant of the present invention and are formed on the inner jacket surface of the housing 1, are shown in FIG. 3. The triangular webs 13 extend in parallel to the central longitudinal axis 7 over the entire length lg of the housing 1 (see FIGS. 1 and 5), which equals 10 mm according to this embodiment.

The cross section of a triangular web 13 is shown in an enlarged view in FIG. 4, an angle, where =90, being formed between the two equal side surfaces 14 and 15 of the triangular web 13. The angle bisectrix 16 of the angle passes through the central longitudinal axis 7 of the ball and socket joint, the triangular web 13 having a radial height of 0.15 mm, which is obtained from the product of the shell thickness Sd (1.5 mm) and the stretch elongation s (10%).

The ball and socket joint housing 1 must be regularly calibrated after its manufacture, i.e., it must be expanded to the correct diameter. A calibrating tool 18, which is shown in FIG. 6 and comprises a plurality of segments 17, is used for this. The calibrating tool 18 has in its center a through hole 19, through which a conical mandrel (not shown) can be driven to push the segments 17 radially apart. However, there is a risk in this connection that the triangular webs 13 may be destroyed. The calibrating tool 18 may be designed for this reason such that it touches the inner jacket surface of the housing 1 at certain points only, so that only triangular webs 13 extending at these points can be destroyed. According to FIG. 6, the calibrating tool 18 touches the inner jacket surface of the housing 1 at eight points, so that only 8 of the 16 triangular webs 13 present here can be destroyed during the calibration. If 16 triangular webs are to be present in the calibrated housing 1, 24 triangular webs 13 must be provided in the housing 1 prior to the calibration for safety's sake.

The number of triangular webs 13 and the number of contact points of the calibrating tool 18 with the housing 1 may, of course, be varied. However, 16 triangular webs are optimal here after the calibration in case of an effective bearing shell radius of r=9.5 mm.

Subsequent to the calibration, the bearing shell 2, designed with a slight oversize concerning the inner circumferential surface of the housing 1, is introduced into the housing 1, so that the triangular webs 13 dig into the bearing shell 2 while the outer circumferential surface of the bearing shell 2 undergoes plastic deformation. An especially effective means of securing the bearing shell 2 against rotation in relation to the housing 1 is thus formed, and, furthermore, dirt and moisture are prevented from entering the area between the bearing shell 2 and the ball and socket joint housing 1 because of a slight oversize of the bearing shell 2 before mounting.

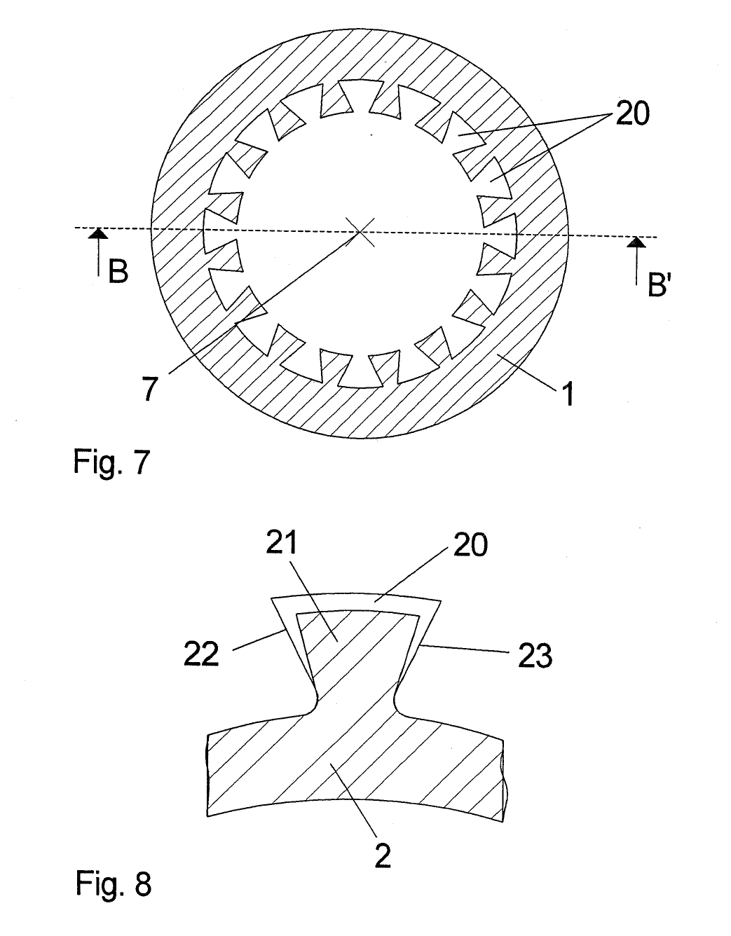

FIG. 7 shows a cross section of a housing 1 according to a second embodiment according to the second variant of the present invention, where the same reference numbers are used for identical or similar features as in the first embodiment. Furthermore, the second embodiment also corresponds to a ball and socket joint according to FIGS. 1 and 2, but a total of 16 undercuts 20, which extend in parallel to the central longitudinal axis 7 and mesh with the bearing shell 2 to form the means securing against rotation, are provided along the inner jacket surface of the housing 1 instead of triangular webs.

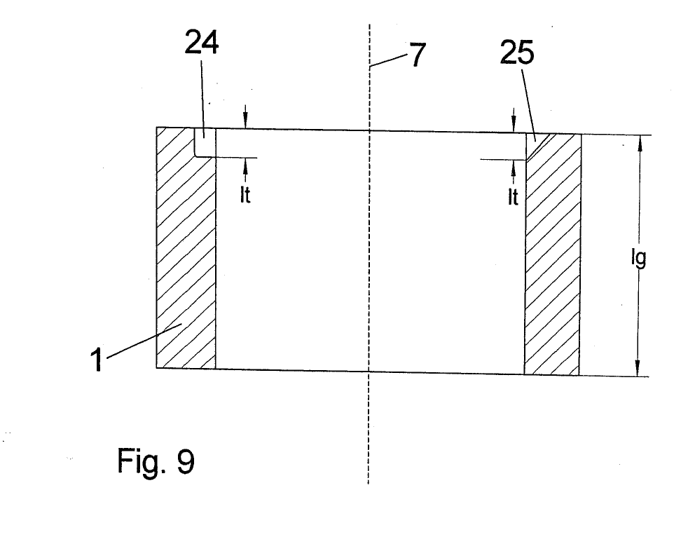

An enlarged view of such an undercut 20 is shown in FIG. 8, the bearing shell 2 meshing with a projection 21 in the undercut 20. The undercuts 20 are open towards a front side of the housing 1 and do not extend over the entire length lg of the inner jacket surface of the housing 1 but over a partial length It only, which is shown in FIG. 9. The securing against rotation between the bearing shell 2 and the housing 1 is designed now such that the collar 9 of the bearing shell 2 projecting radially to the outside from the housing 1 in the partially mounted state is folded over radially towards the outside and is at the same time molded into the undercuts 20. An ultrasonic deformation method is used for this purpose, in particular, while the material of the bearing shell 2 is heated. After the deformation, a so-called material shrinkage takes place during the cooling of the bearing shell material, which causes the projections 21 of the bearing shell 2, which are molded into the undercuts 20, to run radially inwardly against the side walls 22 and 23 of the undercuts 20, as a result of which a permanently good securing of the bearing shell 2 against rotation in relation to the housing 1 is formed.

As is schematically shown in FIG. 9, the undercuts 20 may have a rectangular profile (24) or a triangular profile (25) with respect to a longitudinal section of the housing (1) along the plane of section B-B′ shown in FIG. 7.

Even though only 16 undercuts 20 are shown according to this embodiment, an especially good securing against rotation was obtained when 24 undercuts were formed.

Analogously to the first variant, the bearing shell 2 may be designed with a slight oversize in respect to the inner circumferential surface of the housing 1 according to the second variant of the present invention as well, so that dirt and water can be prevented from entering the area between the bearing shell 2 and the housing 1.

Both variants of the present invention prevent a so-called loosening of the bearing shell 2 from the housing 1. In the first variant, the bearing shell can be introduced into the interior of the housing 1 during plastic deformation of its outer circumferential surface. Since this deformation can take place without a special heating of the material, shrinkage of the material of the bearing shell, which could facilitate the loosening of the bearing shell 2, is avoidable. Furthermore, no oversize of the external diameter of the bearing shell 2 in relation to the internal diameter of the housing 1 is necessary. A slight oversize may, however, be advantageous in order to obtain a sealing effect between the bearing shell 2 and the housing 1. Therefore, the bearing shell 2 can be introduced into the housing 1 without or with only a slight radial prestress, so that the undesired effects of a great radial prestress, which can adversely affect the moments of friction of the ball pivot in the bearing shell, can be avoided. Furthermore, such a great radial prestress is time-dependent because of the behavior of the plastic, so that time dependence of the moments of friction of the ball pivot may become established solely because of the high prestress. This adverse effect can also be avoided with the ball and socket joint according to the present invention. In the second variant, the projections 21 of the bearing shell 2 run firmly into the undercuts 20 because of the shrinkage of the bearing shell material after the deformation, so that the effect of shrinkage contributes here to an improvement rather than to an impairment of the securing against rotation.

While specific embodiments of the invention have been shown and described in detail to illustrate the application of the principles of the invention, it will be understood that the invention may be embodied otherwise without departing from such principles.

1. A ball and socket joint for a motor vehicle comprising:
a housing open on at least one side and having an interior space;
a bearing shell inserted into said housing;
a joint ball of a ball pivot, said joint ball being accommodated, in a slidingly movable manner, in said bearing shell, said interior space having elevations along an inner jacket surface thereof, said elevations meshing with said bearing shell in a positive-locking manner, said elevations being designed as triangular webs.

2. A ball and socket joint in accordance with claim 1, wherein said triangular webs extend in parallel to a central longitudinal axis of said housing.

3. A ball and socket joint in accordance with claim 1, wherein said triangular webs extend over an entire length of the inner surface jacket surface.

4. A ball and socket joint in accordance with claim 1, wherein said triangular webs are formed with two equal side surfaces each and an angle bisectrix of an angle formed between said two equal side surfaces passes through a central longitudinal axis of the bearing.

5. A ball and socket joint in accordance with claim 4, wherein a radial height of said triangular webs is equal to the product of a shell thickness of said bearing shell and a stretch elongation of material used for said bearing shell.

6. A ball and socket joint in accordance with claim 3, wherein a right angle is formed by said two equal side surfaces of each said triangular web.

7. A ball and socket joint in accordance with claim 1, wherein a number of said triangular webs is greater than or equal to an even-numbered, rounded-up quotient of a maximum torque to be transmitted between said housing and said bearing shell to a product of an area of said triangular webs, a shear strength of the bearing shell material as well as an effective bearing shell radius.

8. A ball and socket joint in accordance with claim 1, wherein said bearing shell is made of plastic.

9. A ball and socket joint in accordance with claim 8, wherein said bearing shell is made of polyoxymethylene (POM).

10. A ball and socket joint in accordance with claim 1, wherein said bearing shell has an oversize in relation to the inner jacket surface of said housing.

11. A ball and socket joint for a motor vehicle, comprising:
a housing open on at least one side and having an interior space;
a bearing shell inserted into said housing;
a joint ball of a ball pivot, said joint ball being accommodated, in a slidingly movable manner, in said bearing shell, the interior space having depressions along an inner jacket surface thereof, said depressions meshing with said bearing shell in a positive-locking manner, said depressions being designed as undercuts.

12. A ball and socket joint in accordance with claim 11, wherein said undercuts extend in parallel to a central longitudinal axis of said housing.

13. A ball and socket joint in accordance with claim 11, wherein said undercuts, which are open towards a front side of said housing, extend only over part of a length of said inner jacket surface of said housing.

14. A ball and socket joint in accordance with claim 13, wherein said undercuts have a rectangular profile or a triangular profile in respect to a longitudinal section of said housing.

15. A ball and socket joint in accordance with claim 11, wherein said bearing shell is made of a plastic.

16. A ball and socket joint in accordance with claim 15, wherein said bearing shell is made of polyoxymethylene (POM).

17. A ball and socket joint in accordance with claim 15, wherein the plastic is suitable for ultrasonic deformation.

18. A motor vehicle ball and socket joint, comprising:
a housing having an interior space with an inner surface having a plurality of surface features in the form of triangular webs;
a bearing shell disposed in said interior space of said housing, said surface features engaging said bearing shell in a positive-locking manner;
a joint ball of a ball pivot, said joint ball being accommodated, in a slidingly movable manner, in said bearing shell.

19. A motor vehicle ball and socket joint in accordance with claim 18, wherein said surface features are depressions forming said triangular web.

20. A motor vehicle ball and socket joint in accordance with claim 18, wherein said surface features are elevations forming said triangular web.
